(19) United States
(12) Patent Application Publication
(10) Pub. No.: US 2013/0010361 A1
(43) Pub. Date: Jan. 10, 2013

(54) Optical Polarization Converter System

(75) Inventors: Chien-Chih Hsiung, Taichung City (TW); Yu-Hsiang Huang, Taichung City (TW); Yun-Yi Lin, Taichung City (TW); Li-Yuan Hsu, Taichung City (TW)

(73) Assignee: ASIA OPTICAL CO. INC., Taichung (TW)

(21) Appl. No.: 13/541,844

(22) Filed: Jul. 5, 2012

(30) Foreign Application Priority Data
Jul. 8, 2011 (TW) 100124244

(51) Int. Cl. G02B 27/28

(52) U.S. Cl. 359/489.11

(57) ABSTRACT

An optical polarization converter system includes a plurality of lenses, a light incident surface, a light emitting surface, a first optical coating, a second optical coating and a half-wave plate. The lenses are made of light permeable medium and mutually and tightly arranged. A plurality of basic widths are defined on the light incident surface and the light emitting surface. The first optical coating and second optical coating, configured between the light incident surface and the light emitting surface and having an inclined angle of forty-five degrees relative to the light incident surface, are spaced apart one basic width. The half-wave plate is disposed on the light emitting surface corresponding to one of the first optical coating and the second optical coating. The first and second optical coatings are provided with properties of splitting an incident beam and beam reflection.

### BACKGROUND OF THE INVENTION

1. Field of the Invention

The invention relates to an optical system, and in particular relates to an optical polarization converter system.

2. Description of the Related Art

Referring to FIG. 1, a conventional optical polarization converter system (PCS) 1 used for projector illuminating devices includes a plurality of light permeable prisms 10, a light incident surface 11, a light emitting surface 12, a plurality of polarization beam splitters 13, a plurality of shielding plates 14, a plurality of half-wave plates 15 and an array lens set 16. The polarization beam splitters 13 configured between the light incident surface 11 and the light emitting surface 12 have an inclined angle of forty-five degrees relative to the light incident surface 11. The shielding plates 14 are mutually intervally arranged on the light incident surface 11 and respectively correspond to the polarization beam splitters 13. The half-wave plates 15 are mutually intervally arranged on the light emitting surface 12 and respectively correspond to the polarization beam splitters 13. The array lens set 16 is disposed on the light incident surface 11, including a plurality of sub-lenses 161 which are correspondingly disposed between the shielding plates 14. Each of the sub-lenses 161 of the array lens set 16 has a width approximately equal to the width of two shielding plates 14.

After a light beam passes through the array lens set 16, one part of the light beam is shielded by the shielding plates 14. The other part of the light beam enters the light permeable prisms 10 via the light incident surface 11, wherein a P-type polarized beam is emitted from the light emitting surface 12 after penetrating through the polarization beam splitters 13 and is converted into an S-type polarized beam via the half-wave plates 15. Another S-type polarized beam is emitted from the light emitting surface 12 as being reflected by the polarization beam splitters 13 twice.

From the above descriptions, it is understood that light utilization efficiency is largely reduced due to light shielding by the shielding plates 14. Moreover, current projectors have a tendency to miniaturization. However, the installation of the shielding plates 14 do increase the overall thickness of the optical polarization converter system 1, and the oversized width of the array lens set 16 also increase difficulty on arrangement thereof. Thus, one of the goals for the related manufacturers is to study and develop an optical polarization converter system which is capable of promoting light utilization efficiency and enhancing structural compactness.

### BRIEF SUMMARY OF THE INVENTION

In view of this, the purpose of the invention is to provide an optical polarization converter system and a symmetrical optical polarity conversion module which are capable of promoting light utilization efficiency and enhancing structural compactness.

Accordingly, an optical polarization converter system in accordance with the invention includes a plurality of lenses, a light incident surface, a light emitting surface, a first optical coating, a second optical coating and a half-wave plate. The lenses such as rod lenses or prisms made of light permeable medium are mutually and tightly arranged. The light incident surface is formed on one end surface of the lenses. The light emitting surface formed on another end surface of the lenses is configured to be oppositely parallel to the light incident surface, in which a plurality of basic widths are defined on the light incident surface and the light emitting surface. The first optical coating configured between the light incident surface and the light emitting surface has an inclined angle of forty-five degrees relative to the light incident surface, in which the first optical coating is provided with a property of splitting an incident beam in accordance with its polarity. The second optical coating configured between the light incident surface and the light emitting surface has an inclined angle of forty-five degrees relative to the light incident surface and spaced from the first optical coating at one basic width, in which the second optical coating is provided with a property of beam reflection. The half-wave plate having a width equal to the basic width is disposed on the light emitting surface corresponding to one of the first optical coating and the second optical coating.

Further, the invention provides a symmetrical optical polarity conversion module, comprising a symmetrical middle line and a pair of optical polarization converter systems as mentioned above. The symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.

With the first optical coating and the second optical coating having a property of splitting an incident beam and reflecting a light beam in accordance with their polarities, the invention is capable converting the polarity of the incident beam at each position without shielding the light beam, thereby promoting light utilization efficiency and enhancing structural compactness to surely achieve the purposes of the invention.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a partial side view schematically illustrating a conventional optical polarization converter system and an optical path;

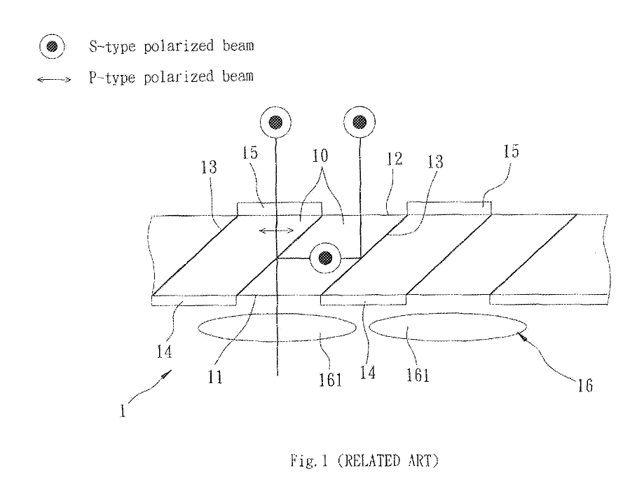

FIG. 2 is a side view of an optical polarization converter system of a first preferred embodiment of the invention; and

FIG. 3 is a side view of an optical polarization converter system of a second preferred embodiment of the invention.

### DETAILED DESCRIPTION OF THE INVENTION

Before describing the invention in detail, it is announced that similar elements are generally denoted by same reference numbers hereinafter.

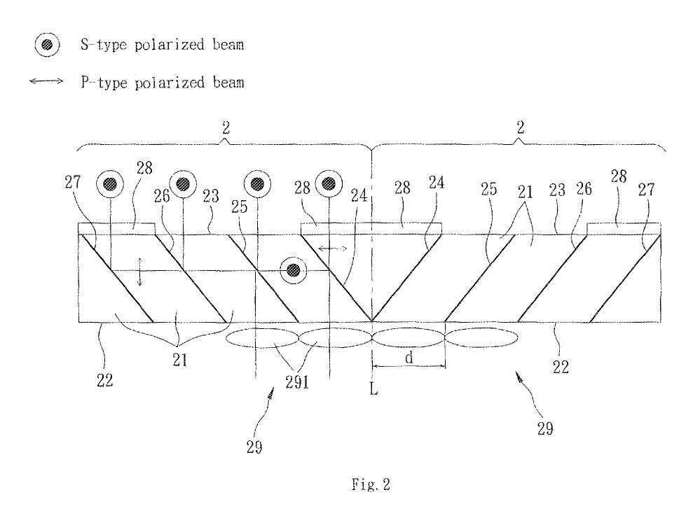

Referring to FIG. 2, an optical polarization converter system 2 of a first preferred embodiment of the invention comprises a plurality of lenses such as prisms 21 or rod lenses, a light incident surface 22, a light emitting surface 23, a first optical coating 24, a second optical coating 25, a third optical coating 26, a fourth optical coating 27, two half-wave plates 28 and an array lens set 29.

The prisms 21 made of light permeable medium are mutually and tightly arranged. The light incident surface 22 is formed on one end surface of the prisms 21. The light emitting surface 23 formed on another end surface of the prisms 21 is configured to be oppositely parallel to the light incident surface 22. A plurality of basic widths d are defined on the light incident surface 22 and the light emitting surface 23.

The first optical coating 24, the second optical coating 25, the third optical coating 26 and the fourth optical coating 27, which are configured between the light incident surface 22 and the light emitting surface 23 in parallel, are sequentially arranged and spaced apart one basic width. Each of the first optical coating 24, the second optical coating 25, the third optical coating 26 and the fourth optical coating 27 has an inclined angle of forty-five degrees relative to the light incident surface 22.

The first optical coating 24 and the third optical coating 26 are provided with a property of splitting an incident beam in accordance with its polarity. In the first preferred embodiment, the first optical coating 24 and the third optical coating 26 have the same polarity beam-splitting property of allowing a penetration of a P-type polarized beam and reflecting an S-type polarized beam. Both of the second optical coating 25 and the fourth optical coating 27 are provided with a property of beam reflection. That is, all incident beams are reflected by the second optical coating 25 and the fourth optical coating 27 regardless of their polarities.

Each of the half-wave plates 28 has a width equal to the basic width d, in which one half-wave plate 28 corresponding to either the first optical coating 24 or the second optical coating 25 is disposed on the light emitting surface 23, and another half-wave plate 28 corresponding to either the third optical coating 26 or the fourth optical coating 27 is disposed on the light emitting surface 23. In the first preferred embodiment, the two half-wave plates 28 corresponding to the first optical coating 24 and the fourth optical coating 27 are disposed on the light emitting surface 23.

The array lens set 29 disposed on the light incident surface 22 includes two sub-lenses 291 which are corresponding to the first optical coating 24 and the second optical coating 25, respectively. Each of the two sub-lenses 291 of the array lens set 29 occupies one basic width d on the light incident surface 22, thereby effectively reducing the difficulty of assembling the optical polarization converter system 2.

The symmetrical optical polarity conversion module of the invention includes a symmetrical middle line L and a pair of above-described optical polarization converter systems 2, in which the symmetrical middle line L is perpendicular to the light incident surface 22 and the light emitting surface 23 of the optical polarization converter systems 2, the symmetrical middle line L is configured between the first optical coatings 24, and the optical polarization converter systems 2 are left-right symmetrical to each other with respect to the symmetrical middle line L.

All light beams passing through the sub-lenses 291 of the array lens set 29 enter the prisms 21. The two sub-lenses 291 which are corresponding to the first optical coatings 24 and the second optical coatings 25 are sequentially described in detail below. With respect to the light beam passing through the sub-lens 291 corresponding to the first optical coatings 24, the P-type polarized beam penetrating through the first optical coatings 24 is emitted from the light emitting surfaces 23 and is converted into an S-type polarized beam when passing through the half-wave plates 28, while the S-type polarized beam reflected by the first optical coatings 24 to the second optical coatings 25 is reflected toward the light emitting surfaces 23 and is emitted therefrom. With respect to the light beam passing through the sub-lens 291 corresponding to the second optical coatings 25, the light beam is reflected toward the third optical coatings 26 by the second optical coatings 25, in which the S-type polarized beam is reflected by the third optical coatings 26 to the light emitting surfaces 23 and is emitted therefrom, while the P-type polarized beam penetrating through the third optical coatings 26 is reflected by the fourth optical coatings 27 to the light emitting surfaces 23 and is converted into an S-type polarized beam when passing through the half-wave plates 28.

With the above-described structure of the optical polarization converter systems 2, all light beams passing through the array lens sets 29 are converted into S-type polarized beams, thereby promoting light utilization efficiency and enhancing structural compactness.

It is worth to mention that the optical polarization converter system 2 still can convert all light beams passing through the array lens sets 29 into S-type polarized beams when only one sub-lens 291 is included in the optical polarization converter system 2 and the third and fourth optical coatings 26 and 27 are excluded therefrom (not shown in any FIGS.).

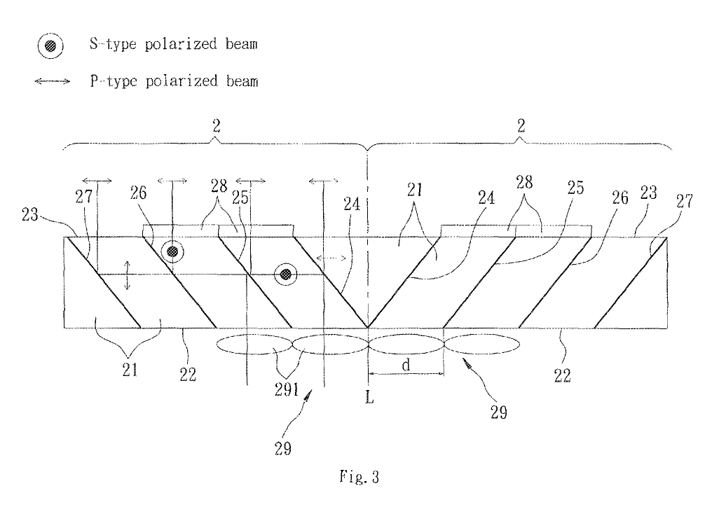

Referring to FIG. 3, an optical polarization converter system of a second preferred embodiment of the invention is illustrated. The first and second preferred embodiment substantially have similar components and assembling method, and the second preferred embodiment differs from the first preferred embodiment in that the positions of the half-wave plates 28 of the second preferred embodiment are changed, thereby converting the emitted beams into P-type polarized beams.

In the second preferred embodiment, the half-wave plates 28 which are corresponding to the second optical coating 25 and the third optical coating 26 are disposed on the light emitting surface 23.

All light beams passing through the sub-lenses 291 of the array lens set 29 enter the prisms 21. The sub-lenses 291 which are corresponding to the first optical coatings 24 and the second optical coatings 25 are sequentially described in detail below. With respect to the light beam passing through the sub-lens 291 corresponding to the first optical coatings 24, the P-type polarized beam penetrating through the first optical coatings 24 is emitted from the light emitting surfaces 23, while the S-type polarized beam is reflected by the first optical coatings 24 toward the second optical coatings 25 and is converted into a P-type polarized beam when passing through the half-wave plates 28. With respect to the light beam passing through the sub-lens 291 corresponding to the second optical coatings 25, the light beam is reflected toward the third optical coatings 26 by the second optical coatings 25, in which the S-type polarized beam is reflected by the third optical coatings 26 to the light emitting surfaces 23, emitted therefrom, and converted into a P-type polarized beam when passing through the half-wave plates 28, while the P-type polarized beam penetrating through the third optical coatings 26 is reflected by the fourth optical coatings 27 to the light emitting surfaces 23 and emitted therefrom.

It is worth to mention that, if the first optical coating 24 has a polarity beam-splitting property different from that of the third optical coating 26 in the optical polarization converter system 2 (e.g., the first optical coating 24 allowing a penetration of a P-type polarized beam and the third optical coating 26 allowing a penetration of an S-type polarized beam), then all light beams passing through the array lens set 29 can be converted into the P-type polarized beams when the half-wave plates 28 corresponding to the second optical coating 25 and the fourth optical coating 27 are disposed on the light emitting surface 23 (not shown in any FIGS.).

In conclusion, with the first optical coating 24 and the second optical coating 25 having a property of splitting an incident beam and reflecting a light beam in accordance with their polarities, the invention is capable converting the polarity of the incident beam at each position without shielding the light beam, thereby promoting light utilization efficiency and enhancing structural compactness to surely achieve the purposes of the invention.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An optical polarization converter system, comprising:
a plurality of lenses, made of light permeable medium and mutually and tightly arranged;
a light incident surface formed on one end surface of the lens;
a light emitting surface formed on another end surface of the lenses and configured to be oppositely parallel to the light incident surface, in which a plurality of basic widths are defined on the light incident surface and the light emitting surface;
a first optical coating, configured between the light incident surface and the light emitting surface and having an inclined angle of forty-five degrees relative to the light incident surface, in which the first optical coating is provided with a property of splitting an incident beam in accordance with a polarity of the incident beam;
a second optical coating, configured between the light incident surface and the light emitting surface, having an inclined angle of forty-five degrees relative to the light incident surface and spaced from the first optical coating at one basic width, in which the second optical coating is provided with a property of beam reflection; and
a half-wave plate having a width equal to one basic width and disposed on the light emitting surface corresponding to one of the first optical coating and the second optical coating.

2. The optical polarization converter system as claimed in claim 1 further comprising an array lens set disposed on the light incident surface, in which the array lens set comprises a sub-lens corresponding to the first optical coating and occupying one basic width on the light incident surface.

3. The optical polarization converter system as claimed in claim 1 further comprising a third optical coating, a fourth optical coating, and another half-wave plate which is disposed on the light emitting surface and corresponding to one of the third optical coating and the fourth optical coating, in which the first optical coating, the second optical coating, the third optical coating and the fourth optical coating are sequentially arranged and spaced apart one basic width; the third optical coating and the fourth optical coating configured between the light incident surface and the light emitting surface have an inclined angle of forty-five degrees relative to the light incident surface; the third optical coating is provided with a property of splitting the incident beam in accordance with the polarity of the incident beam; and the fourth optical coating is provided with a property of beam reflection.

4. The optical polarization converter system as claimed in claim 3, wherein the first optical coating and the third optical coating have same polarity beam-splitting property, and the half-wave plates corresponding to the first optical coating and the fourth optical coating are disposed on the light emitting surface.

5. The optical polarization converter system as claimed in claim 3, wherein the first optical coating and the third optical coating have same polarity beam-splitting property, and the half-wave plates corresponding to the second optical coating and the third optical coating are disposed on the light emitting surface.

6. The optical polarization converter system as claimed in claim 3 further comprising an array lens set disposed on the light incident surface, in which the array lens set comprises two sub-lenses which are respectively corresponding to the first optical coating and the second optical coating and occupying one basic width on the light incident surface.

7. A symmetrical optical polarity conversion module comprising a symmetrical middle line and a pair of optical polarization converter systems as claimed in claim 1, in which the symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.

8. A symmetrical optical polarity conversion module comprising a symmetrical middle line and a pair of optical polarization converter systems as claimed in claim 2, in which the symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.

9. A symmetrical optical polarity conversion module comprising a symmetrical middle line and a pair of optical polarization converter systems as claimed in claim 3, in which the symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.

10. A symmetrical optical polarity conversion module comprising a symmetrical middle line and a pair of optical polarization converter systems as claimed in claim 4, in which the symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.

11. A symmetrical optical polarity conversion module comprising a symmetrical middle line and a pair of optical polarization converter systems as claimed in claim 5, in which the symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.

12. A symmetrical optical polarity conversion module comprising a symmetrical middle line and a pair of optical polarization converter systems as claimed in claim 6, in which the symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.

13. The optical polarization converter system as claimed in claim 1, wherein the lenses are rod lenses.

14. The optical polarization converter system as claimed in claim 1, wherein the lenses are prisms.

15. A symmetrical optical polarity conversion module comprising a symmetrical middle line and a pair of optical polarization converter systems as claimed in claim 13, in which the symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.

16. A symmetrical optical polarity conversion module comprising a symmetrical middle line and a pair of optical polarization converter systems as claimed in claim 14, in which the symmetrical middle line is perpendicular to the light incident surface and the light emitting surface of the optical polarization converter systems, the symmetrical middle line is configured between the first optical coatings of the optical polarization converter systems, and the optical polarization converter systems are left-right symmetrical to each other with respect to the symmetrical middle line.
